(19) United States
(12) Patent Application Publication
(10) Pub. No.: US 2025/0170714 A1
(43) Pub. Date: May 29, 2025

(54) CONTROL SYSTEM AND CONTROL METHOD

(71) Applicant: HITACHI, LTD., Tokyo (JP)

(72) Inventors: Kanta HAMASAKI, Tokyo (JP); Azuma OKUNO, Tokyo (JP); Juri SHIMIZU, Tokyo (JP); Yuji Andre YASUTOMI, Tokyo (JP); Satoshi NAKAMURA, Tokyo (JP)

(21) Appl. No.: 18/842,466

(22) PCT Filed: Dec. 26, 2022
(86) PCT No.: PCT/JP2022/047849

§ 371 Date: Aug. 29, 2024

(30) Foreign Application Priority Data
Mar. 14, 2022 (JP) 2022-038837

(51) Int. Cl. B25J 9/16; B25J 9/00

(52) U.S. Cl. CPC B25J 9/1653; B25J 9/0084; B25J 9/1661

(57) ABSTRACT

A control system is capable of planning an efficient process in consideration of the influence of operational constraints, and executing control consistent with a planned process. The control system, which controls each of a plurality of robots operating in the same work environment, has a control parameter calculation unit that calculates control parameters for the plurality of robots; an optimization unit that generates a step for the plurality of robots on the basis of the control parameters; a task module selection unit that selects a task module for each of the plurality of robots on the basis of the step; and a control unit that controls the plurality of robots on the basis of the task module. When execution times of the tasks in an influence relationship overlap, the optimization unit constrains the task of the other robots.

### TECHNICAL FIELD

The present invention relates to a control system and method in which a plurality of robots perform various tasks in a non-maintenance environment.

### BACKGROUND ART

Recently, labor shortages due to the shrinking birthrate and aging population, work in dangerous areas due to natural disasters, etc. have become socially problematic. To solve these problems, it is expected that robots will be activated in environments other than well-maintained spaces like factories where they are easily controlled (non-maintained environments). In order to efficiently execute a variety of tasks in non-maintained environments, there is a need to simultaneously control a plurality of robots different in performance.

Patent Document 1 is accompanied by the problem of process insufficiency due to fluctuations in the execution time of the task in view of a plurality of robots that share and execute a plurality of tasks, and proposes a plan generating device that among candidate tasks that the robot can next execute, executes the task which will minimize a waiting time until execution.

### CITATION LIST

### Patent Literature

### Patent Literature 1: Japanese Unexamined Patent Application Publication No. 2019-197367

### SUMMARY OF INVENTION

### Technical Problem

In processes executed in a maintained environment, as restriction conditions between tasks, there are provided restrictions on the order of work and restrictions to avoid the competition between work positions and tools. On the other hand, in processes executed in a non-maintenance environment, those restriction conditions alone are not sufficient, and there is a need to take into consideration restrictions on other tasks (operation restrictions) due to physical phenomena such as vibrations and noise associated with the execution of tasks.

For example, as to a plurality of robots working on the unstable ground, vibrations in the ground caused by a robot that performs a task involving high-speed movement may adversely affect on other robots that perform a task such as inserting bolts, which requires precise positioning, thereby causing a risk that the latter task fails. In such a case, changing the control parameters of the former task may enable the latter task to be performed.

Therefore, in order to carry out a safe and efficient process in a non-maintained environment, there is a need to take into consideration operation restrictions, but Patent Document 1 does not anticipate the operation restrictions.

In view of the above, it is an object of the present invention to provide a control system and method which can plan an efficient process taking into consideration the effects of operation restrictions and can execute control which is consistent with the planned process.

### Solution to Problem

As described above, according to a present invention, “a control system which controls each of a plurality of robots operated in the same work environment, includes: a control parameter calculation unit which calculates control parameters for the plurality of robots; an optimization unit which generates processes for the plurality of robots based on the control parameters; a task module selection unit which selects a task module for each of the plurality of robots based on the processes; and a control unit which controls the plurality of robots based on the task modules. In the control system, the optimization unit restricts a task of the other robot when execution times of tasks affecting each other overlap.”

Further, in the present invention, “a control system which controls each of a plurality of robots operated in the same work environment, includes: a control parameter calculation unit which calculates control parameters for the plurality of robots; an optimization unit which generates processes for the plurality of robots based on the control parameters; a task module selection unit which selects a task module for each of the plurality of robots based on the processes; and a control unit which controls the plurality of robots based on the task modules. In the control system, when execution times of tasks affecting each other overlap, the control parameter calculation unit imposes an operation restriction on the operation of the other robot in order to reduce the effect on the task execution of one robot, to calculate the control parameters, and when the execution times of the tasks affecting each other overlap, the optimization unit calculates the time required for the other robot to execute the task based on the control parameters for the other robot, and generates processes for the plurality of robots based on the calculation results.”

Further, in the present invention, “a control method of controlling each of a plurality of robots operated in the same work environment, includes the steps of: calculating control parameters for the plurality of robots; generating processes for the plurality of robots based on the control parameters; selecting a task module for each of the plurality of robots based on the processes; and controlling the plurality of robots based on the task modules; and restricting a task of the other robot when execution times of tasks affecting each other overlap.”

### Advantageous Effects of Invention

According to the present invention, it is possible to plan an efficient process taking into consideration the effects of operation restrictions and to execute control which is consistent with the planned process.

### BRIEF DESCRIPTION OF DRAWINGS

FIG. 1 is a diagram showing an example in which a plurality of robots execute a plurality of tasks in a non-maintenance environment.

FIG. 2 is a diagram showing a configuration example of a control system according to a first embodiment of the present invention.

FIG. 3 is a flowchart showing the general flow of processing between a plan generation section 12 and a robot R.

FIG. 4 is a flowchart showing the flow of processing of a robot.

FIG. 5 is a diagram showing an example of information D on tasks stored in a storage unit 11.

FIG. 6 is a diagram showing an example of a method of calculating control parameters of the task information.

FIG. 7 is a diagram showing an example of a partial process obtained in the process of optimizing a process by an optimization unit 15.

FIG. 8 is a diagram showing an example of a method of calculating an execution time of a task requested to provide operation restrictions.

FIG. 9 is a diagram showing a configuration example of a control unit 19.

FIG. 10 is a diagram showing a process finally generated in the plan generation section 12.

FIG. 11 is a diagram showing task information D of the storage unit 11 added in a second embodiment.

FIG. 12 is a diagram showing a work environment of a robot in the second embodiment.

FIG. 13 is a diagram showing a method of calculating a control parameter of the task information in the second embodiment.

FIG. 14 is a diagram showing work environments of robots and an unmanned aircraft in a third embodiment.

FIG. 15 is a diagram showing task information of the storage unit 11 added in the third embodiment.

FIG. 16 is a diagram showing a method of calculating a control parameter of the task information in the third embodiment.

FIG. 17 is a diagram showing a configuration example of a control system according to the third embodiment.

FIG. 18 is a flowchart showing the flow of processing of the entire control system according to the third embodiment.

FIG. 19 is a diagram showing a configuration when there is a task module 40 with remote control.

FIG. 20 is a diagram showing a configuration of a control system according to a fifth embodiment.

FIG. 21 is a flowchart showing the flow of processing of the entire control system according to the fifth embodiment.

FIG. 22 is a diagram showing the configuration of a task insert (x, y) in a sixth embodiment.

FIG. 23 is a diagram showing operation restrictions of the task insert (x, y) in the sixth embodiment.

### DESCRIPTION OF EMBODIMENTS

The following describes the embodiments of the present invention with reference to the drawings.

### First Embodiment

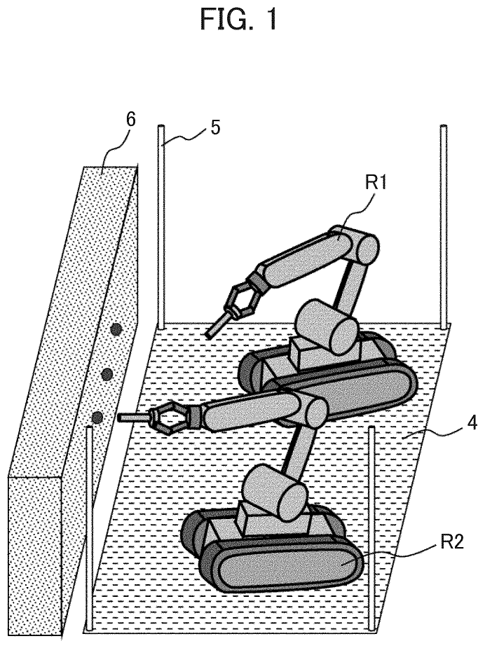

The present invention is a control system which plans and controls processes in which a plurality of robots perform a plurality of tasks in a non-maintenance environment. In explaining it, it is assumed that a plurality of robots perform a plurality of tasks in the non-maintenance environment shown in FIG. 1.

In the work environment (non-maintenance environment) shown in FIG. 1, robots R1 and R2 perform work for a wall 6 on an unstable work floor 4 which is suspended by ropes 5. Here, it is assumed that the work floor 4 is in a situation of being suspended by ropes 5, but this may be replaced with another situation in which work is performed on an unstable ground such as an elastic floor like a grating. The situation shown in FIG. 1 corresponds to, for example, a construction site, a maintenance inspection of a structure, and the like.

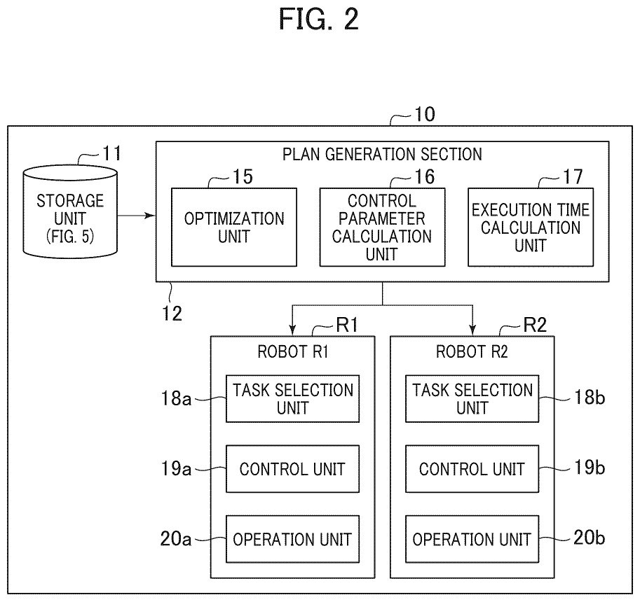

FIG. 2 is a diagram showing a configuration example of a control system according to a first embodiment of the present invention. The control system 10 is comprised of a storage unit 11, a plan generation section 12, and robots R1 and R2. The control system 10 is configured using two sets of upper and lower computer devices and gives operation commands determined by the upper computer device using the plan generation section 12 to the robots R1 and R2 being the lower computer device via communication. The robots R1 and R2 execute operations according to the operation commands and transmit various pieces of information measured on the robot side to the plan generation section 12 as appropriate, so that the information is reflected in the creation of subsequent operation commands.

Of these, although the plan generation section 12 will be described in detail later, the plan generation section 12 includes the functions of a control parameter calculation unit 16 which calculates control parameters corresponding to each of a plurality of robots R, an execution time calculation unit 17 which determines an execution time of a task for each of the plurality of robots R, and an optimization unit 15 which generates processes for the plurality of robots, based on the control parameters and the execution time of each task.

Further, the plurality of robots R have a task module selection unit 18 which selects a task module for each of the plurality of robots based on the process, a control unit 19 which controls the plurality of robots based on the task modules, and an operation unit 20 which mechanically drives the operating ends of the robots, such as their arms and legs. Incidentally, in the example of FIG. 1, the functions performed by the upper and lower computer devices are allocated as described above, but it is possible to appropriately determine which computer device should be given what level of functions.

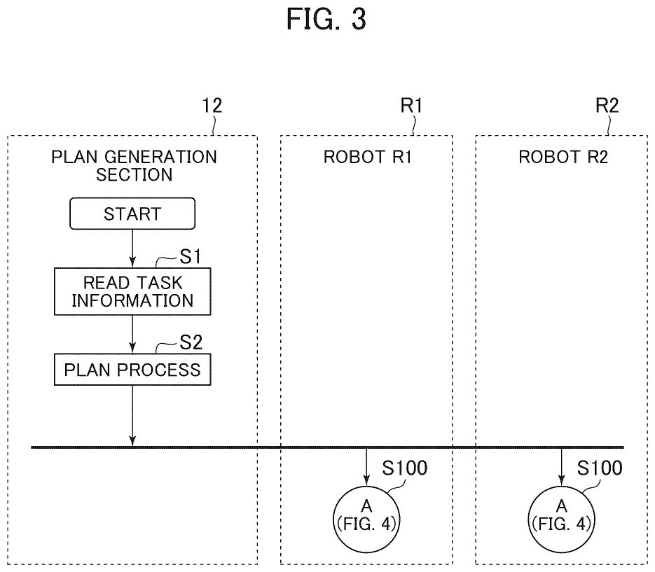

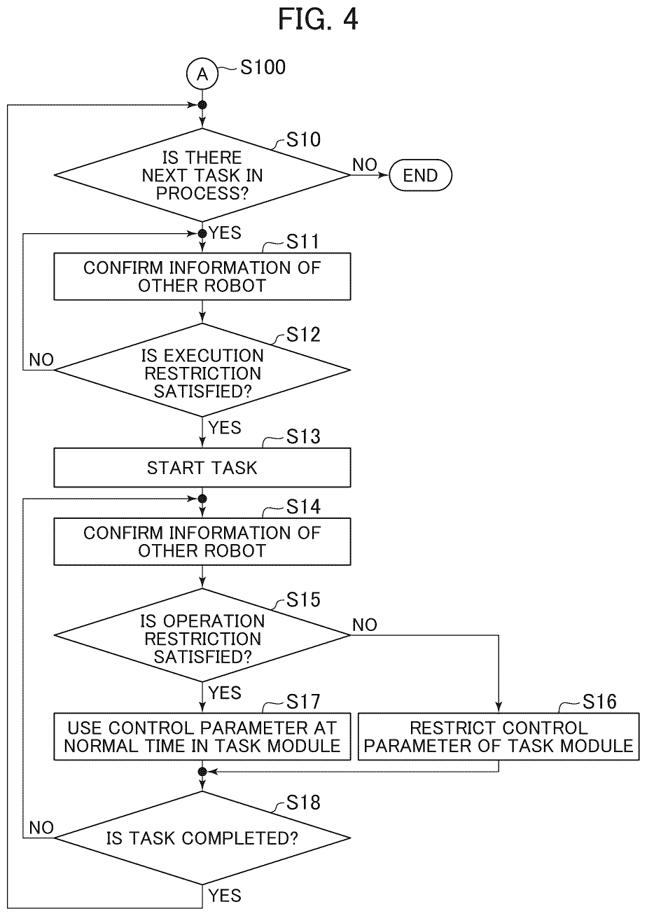

FIG. 3 is a diagram showing the general flow of processing between the plan generation section 12 and the robots R1 and R2, which are the upper and lower computer devices respectively. According to this figure, in a processing step S1 of the plan generation section 12, information on tasks that can be carried out by the robots R1 and R2 is read from the storage unit 11. Next, in a processing step S2 of the plan generation section 12, the process of each robot is planned and given to the robots R1 and R2 as an operation command. The robots R1 and R2 execute a processing step S100 whose details are shown in FIG. 4.

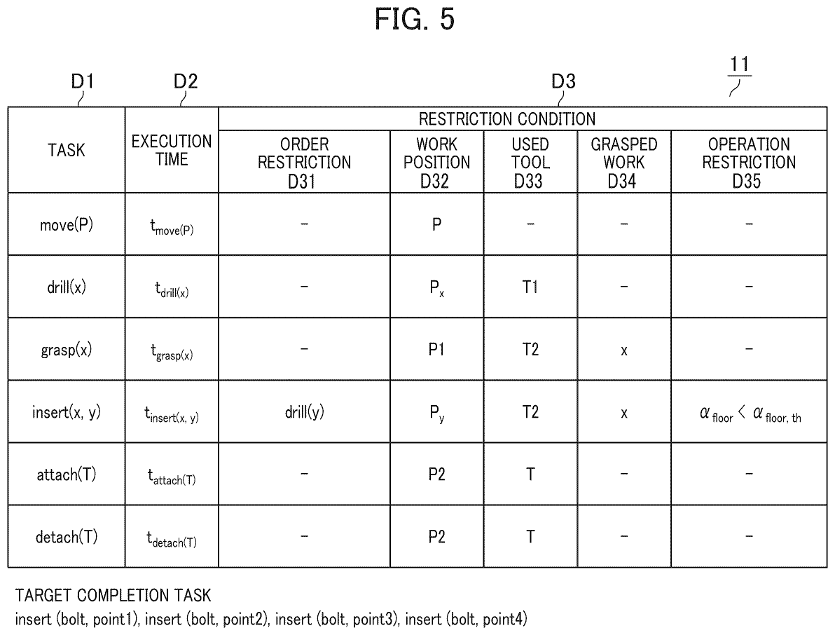

The detailed flow of processing will hereinafter be described sequentially from the upper level side. First, FIG. 5 is an example of task information D stored in the storage unit 11. The task information D includes at least a task name Dl, a task execution time D2, or a restriction condition D3 on executing each task.

Among these, the take name D1 defines the type of task to be executed by the robot, and prepares move, drill, grasp, insert, attach, detach, etc. depending on its operation content. Here, the task is described as “task name (target 1, target 2)”, and one or more targets for executing the task are specified in parentheses.

Incidentally, the task of the robot can be defined by a control parameter. The control parameter is a parameter which controls the operation of the robot while it is executing the task. Here, an example will be described in which the maximum moving speed Vₘₐₓ is used as the control parameter. Incidentally, it is assumed that information on the control parameters is also stored in the storage unit 11.

Even if these tasks illustrated in FIG. 5 have the same task name, the execution time and the restriction condition differ depending on the object. Therefore, the task information D sets the task execution time D2 and restriction condition D3 individually for each individual task name D1.

Of these, the execution time D2 is distinguished and denoted by adding the symbol used in the name of each task after the symbol t indicative of the time. The execution time t is an estimated required time taken from the start of the task to its completion. The restriction condition D3 indicates a task which must be completed when starting the task. In this example, a sequence restriction D31, a work position D32, a used tool D33, a grasped work D34, and an operation restriction D35 are given. The present invention is characterized in that the concept of the operation restriction D35 is introduced.

A detailed description will be made below about the matters that are meant by the restriction condition D3. First, in terms of the sequence restriction D31 in FIG. 5, with respect to drill (y) described herein, a task insert (x, y) which inserts an object x into an object y indicates that it needs to be executed after the task drill (y) which drills a hole.

A work position P described in the work position D32 of FIG. 5 is an area occupied when executing the task. The work position P indicates that, while the task is being executed, a robot other than the robot executing the task must not enter the work position P. Note that Pₓ represents the position where the object x exists.

The used tool T described in the used tool D33 of FIG. 5 is a tool used when executing the task, and indicates that the tool T must not be used by the robot other than the robot executing the task while the task is being executed.

A grasped work described in the grasped work D34 of FIG. 5 is a work used when executing the task, and indicates that, while the task is being executed, no robot other than the robot executing the task must be using the work.

An operation restriction described in the operation restriction D35 of FIG. 5 is a restriction condition on a physical quantity as to whether or not the task is executed. The example of FIG. 5 indicates that an acceleration α_{floor} of the vibration of the work floor 4 needs to be smaller than a threshold value α_{floor, th} while the task insert (x, y) is being executed. This means that the task insert (x, y) is a precise work and will fail if the vibration of the work floor 4 is too large.

Therefore, in the present invention, while the task is being executed, for example, the control parameters of other tasks are changed to make a situation in which the operation restriction is satisfied, thereby making it possible to execute the task. Here, it is also possible to give different threshold values α_{floor, th, insert (x, y)} to objects x, y different in the task name insert. Further, although the insertion of a bolt is given as an example of the precise work here, it can be replaced with cutting or painting the work object, an assembly which requires alignment, object recognition, etc.

A plurality of target completion tasks are further set in the storage unit 11 as a part of the task information D of FIG. 5. The target completion tasks in this example include processing (insert (bolt, point1)) in which the robot R inserts a bolt into a point 1, processing (insert (bolt, point2)) in which the robot R inserts a bolt into a point 2, processing (insert (bolt, point3)) in which the robot R inserts a bolt into a point 3, and processing (insert (bolt, point4)) in which the robot R inserts a bolt into a point 4, at the work site in FIG. 1. All of these processing need to be completed.

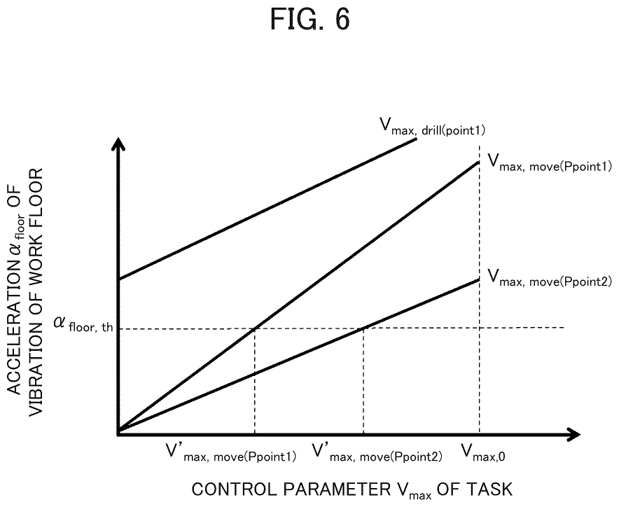

FIG. 6 is a diagram describing a method of calculating the control parameters stored in the storage unit and shows the relationship between the maximum moving speed Vₘₐₓ which is the control parameter of each task on the horizontal axis, and the acceleration α_{floor} of the vibration of the work floor on the vertical axis. V_{max, 0} on the horizontal axis is the maximum moving speed at a normal time. When it is not necessary to consider the operation restriction, the task is executed at V_{max, 0}.

In the example of FIG. 6, since, even in any task, the acceleration α_{floor} of the vibration is also increased with the control parameter Vₘₐₓ, Vₘₐₓ which becomes α_{floor} (Vₘₐₓ)=α_{floor, th} becomes the optimal value V′ₘₐₓ.

On the other hand, the task drill (point) shows that since even for any of the control parameters V_{max, drill (point1)}, α_{floor} (V_{max, drill (point1))} is larger than α_{floor, th} (α_{floor} (V_{max, drill (point1)})>α_{floor, th}), the task insert (x, y) and the task drill (point1) cannot be executed simultaneously.

For the acquisition of the threshold value α_{floor, th}, for example, when a task which requires an operation restriction and a task for which an operation restriction is required are executed with an acceleration sensor attached to the work floor 4, and the control parameter of the latter task is made small, α_{floor} at which the former task is successful is denoted as α_{floor, th}. Other methods can also be considered including evaluating the above procedure on a simulation, or evaluating only the former task on an experimental device capable of reproducing the vibration of the work floor 4.

Here, the physical quantity for setting the threshold value does not necessarily have to be α_{floor}, and is not problematic as long as it is a physical quantity which can be an indicator of task failure, such as acceleration obtained from a sensor mounted on the robot itself or the amount of blurring in an image obtained from a camera.

Also, in FIG. 6, the task drill (point1), move (Pₚₒᵢₙₜ₁), and move (Pₚₒᵢₙₜ₂) are extracted as an example, but the relationship can be shown similarly even for other tasks.

Further, in addition to the moving speed, it is also possible to set a moving acceleration, a moving angular speed, a moving angular acceleration, a moving speed in a specific direction, and the like as control parameters in accordance with the work environment and the nature of the task.

For example, when there is robustness against the vibration of the work floor 4 in the axial direction of the bolt in terms of the task insert (bolt, point1), the operation restriction is set as α_{floor, perp}<α_{floor, th}, which imposes a condition on an acceleration α_{floor, perp} of the vibration of the work floor 4 in the direction perpendicular to the axis of the bolt. Then, the control parameter of each task in FIG. 6 is set to be the maximum moving speed V_{max, perp} in the axial direction instead of Vₘₐₓ. Further, in FIG. 6, the relationship between Vₘₐₓ and α_{floor} is represented by a linear function, but it is conceivable that it is also expressed by a nonlinear function.

In FIG. 6, the condition for the physical quantity is described as the operation restriction, but the relationship between the physical quantity and the control parameter Vₘₐₓ is calculated in advance, or the control parameter Vₘₐₓ at which the task does not fail is directly measured, whereby it is also possible to describe the control parameter itself as in the case of, for example, V_{max, drill (point1)}=0.3 [m/s], V_{max, move} (Pₚₒᵢₙₜ₁)=1.5 [m/s], . . . .

The restriction condition D3 shown in FIG. 5 can be expanded or reduced depending on the work environment and the type of task. Upon utilizing the control system according to the present invention, at least the operation restriction D3 is required to be included.

Returning to FIG. 2, in the processing step S2, the plan generation section 12 plans the process of each robot R1 and R2 comprised of the tasks shown in FIG. 5. The optimization unit 15, the control parameter calculation unit 16, and the execution time calculation unit 17 in the plan generation section 12 are used to implement the processing step S2.

The optimization unit 15 creates a process of meeting the restriction condition of each task shown in FIG. 5 and capable of completing all target completion tasks shown in FIG. 5, and searches for such a process as to minimize an evaluation value such as an end time and power consumption.

Searching methods for the optimal process include a graph search algorithm (greedy method, A* algorithm, or the like), metaheuristics (progressive algorithm, annealing method, or the like), and reinforced learning, etc. For example, when the A* algorithm is used, the partial process with some tasks assigned is used as one node, and the optimal process is retrieved by developing a node where an evaluation function is minimal. In the present embodiment, the case where the A* algorithm is used will be described, but the similar processing can be executed even when other methods are used.

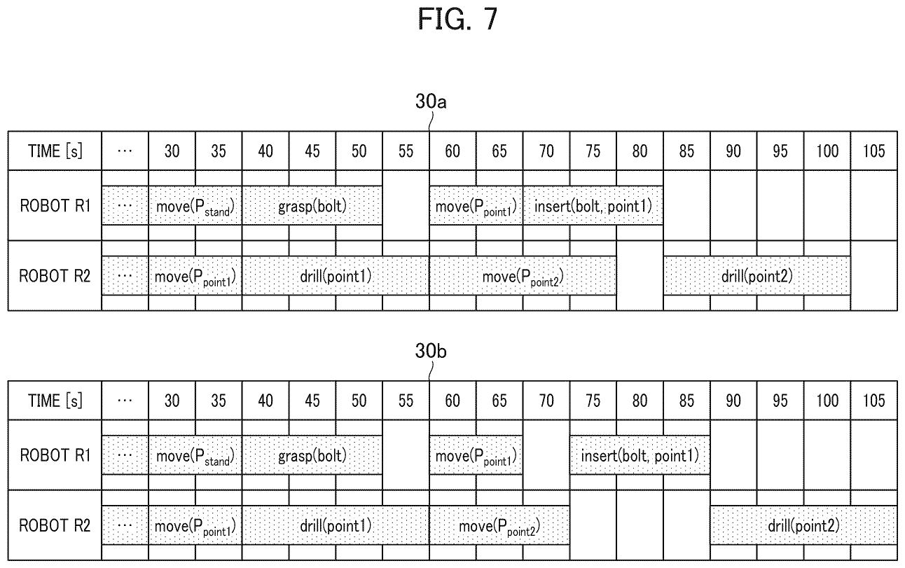

FIG. 7 is an example of a partial process obtained in the process of optimizing a process by the optimization unit 15. Both partial processes 30a and 30b are in a state of being assigned only insert (bolt, point1) among the target completions tasks.

In the case of the partial processes 30a and 30b, the robot R2 is in charge of the role of moving to a predetermined hole digging location and digging a hole, and the robot R1 performs the role of holding a bolt, moving to the position of the hole, and inserting the bolt therein with an appropriate time delay.

Incidentally, while the robot R2 is executing the task drill (point1) according to the restriction condition D32 of the work position, the robot R1 cannot execute the task move (Pₚₒᵢₙₜ₁). Therefore, the move (Pₚₒᵢₙₜ₁) of the robot R1 is started after the drill (point1) of the robot R2 is completed.

In the processing of the processing step S2, the execution time calculation unit 17 calculates an execution time t of each task required to create each of the partial processes 30a and 30b. The execution time t of a task other than a task with the operation restriction is an execution time to at the normal time. For example, the execution time t is given at a constant value as in the case of t_{0, drill (point1)}=20 [s], t_{0, move (Ppoint2)}=15 [s], . . . .

On the other hand, as for such tasks as to be executed simultaneously with the task insert (bolt, point1) of the robot R1 which require the operation restrictions as in the task move (Pₚₒᵢₙₜ₂) of the robot 2 of the partial process 30a, the execution time is calculated based on the change of the control parameter caused by the operation restriction.

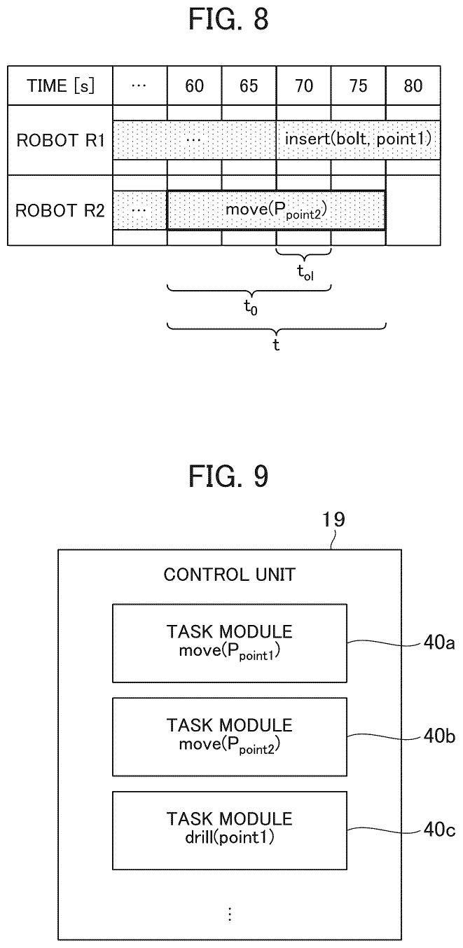

FIG. 8 is a diagram describing a method of calculating the execution time of the task move (Pₚₒᵢₙₜ₂) of the robot R2 in the partial process 30a of FIG. 7. Assuming that, of the execution time t₀ of the task move (Pₚₒᵢₙₜ₂) at the normal time, the time when the execution is overlapped with the task insert (bolt, point1) is t₀₁, the actual execution time t of the task move (Pₚₒᵢₙₜ₂) is calculated from t=t₀+t₀₁ (V_{max, 0}/V′ₘₐₓ−1).

Here, V′ₘₐₓ is calculated based on the task information shown in FIG. 6 in the control parameter calculation unit 16. At this time, it is assumed that the moving speed from the start to completion of the task is always the maximum moving speed. The method of calculating the execution time is not limited to this, and, for example, a method of considering a more detailed speed distribution, a method of utilizing analysis results by simulation, etc. are also conceivable.

Further, in the case where the control parameter is greatly restricted due to the operation restriction, etc., it may be more efficient in process when making it not to overlap the execution of each task requesting the operation restriction and the execution of the task for which the operation restriction is required each other.

The partial process 30b of FIG. 7 is a partial process created so that the execution of the task insert (bolt, point1) of the robot R1 requiring the operation restriction and the execution of the task move (Pₚₒᵢₙₜ₂) of the robot R2 for which the operation restriction is required do not overlap. Comparing the partial processes 30a and 30b, the partial process 30a is earlier in end time, but the optimal process is determined based on the evaluation value of the final process assigned all the target completion tasks.

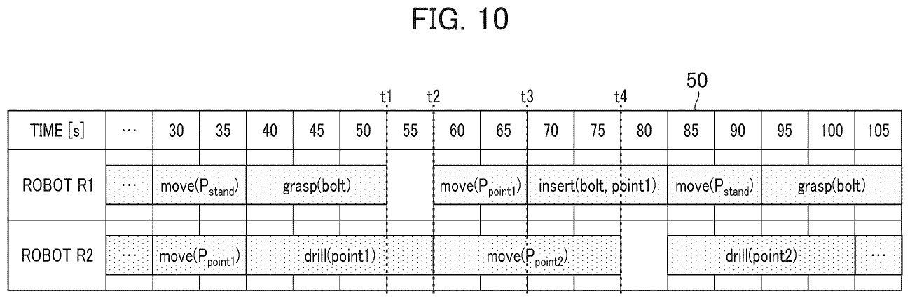

Thus, in the plan generation section 12, as the optimal process in executing all the target completion tasks, the final process 50 shown in FIG. 10 is determined. The optimal process is given to each of the robots R1 and R2 as an operation command. Each of the robots R1 and R2 given the operation command executes the processing step S100 showing the details in FIG. 4.

Of a series of flows of the processing step S100 of FIG. 4 in the robot R, the controls of the robots R1 and R2 are performed in parallel after the processing step S10. Here, the processing steps S10 to S13 are performed in the task selection unit 18 in FIG. 2, and the processing steps S14 to S18 are performed in the control unit 19 in FIG. 2.

FIG. 9 is a diagram showing a configuration example of the control unit 19. The control unit 19 includes a task module (control program) 40 for the robots R1 and R2 to execute each task in FIG. 5. When the task module 40 is started up in the control unit 19, the operation unit 20 controls the robot R1 or the robot R2, based on the program described in the task module.

The description method of the task module 40 is optional, but there is described a control command for executing a series of operations that, for example, in the case of a task module drill (point1), the tip of the drill attached to the robot is approached to point1 to drill the point1 while rotating the drill bit, and the tip returns to the approach position when drilling is completed to a specified depth.

Return to FIG. 4, and in the first processing step S10, the task to be executed next is selected in accordance with the order of the final process 50 shown in FIG. 10 generated in the processing step S2. If there is a task to be executed next, the processing proceeds to the processing step S11. If there is no task to be executed next, the processing is terminated as the series of all tasks to be processed by the robot have been executed.

In the processing step S11, check the task executed by the robot R2 for the robot R1, and the task executed by the robot R1 for the robot R2. In the processing step S12, it is determined whether or not the task to be executed next satisfies an execution restriction.

The execution restriction is a restriction satisfied when the start time of a task to be executed next is earlier than the estimated completion time of a task currently being executed by the other robot R. For example, in the process 50 of FIG. 10, when the execution restriction of the next task move (Pₚₒᵢₙₜ₁) is confirmed at a time t1 when the task grasp (bolt) of the robot R1 is completed, an estimated completion time t2 of the task drill (point1) being executed by the robot R2 is the same as the start time t2 of grasp (bolt) at that time, and hence the execution restriction is not satisfied.

In that case, the processing steps S11 and S12 are repeated until the execution restriction is satisfied. In the process 50, the robot R1 proceeds to the processing step S13 at the time t2.

Here, in the processing step S12, instead of the execution restriction, all of the restriction conditions D3 shown in FIG. 5 may be judged. In that case, however, even in a process which is deliberately planned so that the task insert (bolt, point1) requiring the operation restriction D35 and the task move (Pₚₒᵢₙₜ₂) for which the operation restriction is required do not overlap, as shown in the partial process 30b of FIG. 7, it is necessary to be able to make such a determination as not to start the task insert (bolt, point1) during the execution of the task move (Pₚₒᵢₙₜ₂).

In the processing step S13, the task module 40 in FIG. 9 related to the task selected in the processing step S10 is started up, and the control of the robot R based on the task module 40 is started.

In the processing step S14, the task to be executed by the other robot R is confirmed, and in the processing step S15, a determination as to the operation restriction D35 of the task is made. If the task is a task which requires the operation restriction D35, and the task executed by the robot R being under the control do not satisfy the required operation restriction D35, then in the processing step S16, the control parameter of the task module 40 executed by the controlling robot R is restricted.

On the other hand, if in the processing step S15, the task of the other robot R is a task that does not require the operation restriction D35, or is a task that requires the operation restriction D35, but if the task being executed by the controlling robot R already satisfies the operation restriction D35, then the control parameter at the normal time is used in the task module 40.

Then, in the processing step S18, it is confirmed whether or not the task module 40 executed by the controlling robot R has been completed, and if it is determined to be completed, the processing returns to the processing step S10, where the next task is processed. If it is determined in the processing step S18 that the task module 40 is not completed, the processing returns to the processing step S14, where determination and processing as to the operation restriction D35 are performed until the task module 40 is completed.

Finally, when it is determined in the processing step S10 that there is no next task in the process 50, the control of the robot R is terminated.

For example, in the process 50 of FIG. 10, it is determined in the processing step S15 that the operation restriction D35 for the robot R2 is satisfied between the times t2 and t3. Therefore, the task module move (Pₚₒᵢₙₜ₂) is executed with the control parameter V_{max, 0} at the normal time.

On the other hand, since the task insert (bolt, point1) executed by the robot R1 requires the operation restriction D35 between the times t3 and t4, it is determined in the processing step S15 that the operation restriction D35 for the robot R2 is not satisfied. The task module move (Pₚₒᵢₙₜ₂) is executed with the restricted control parameter V′ₘₐₓ.

Although the method of changing the control parameter inside the task module 40 has been described above, there is no problem even with a method of preparing a plurality of task modules different only in control parameter. In this case, in the processing step S16 of FIG. 4, the control unit 19 performs the processing of switching from a task module having a control parameter at the normal time to a task module having a restricted control parameter.

By changing the control parameters while taking into consideration the characteristics of other tasks with the overlapping execution times as described above, it is possible to plan an efficient process having taken into consideration the operation restriction and to execute control which is consistent with the planned process.

Incidentally, in the above description, there has been explained the case of changing the control parameters, but this may be any case as long as the operation is restricted (constrained) in accordance with the establishment of the conditions of the operation restriction D35. The operation restriction includes stopping the operation, delaying the operation, or slowing down the operation. Changing the control parameters is merely specific means for realizing the operation restriction, and the operation restriction may be implemented by other means.

### Second Embodiment

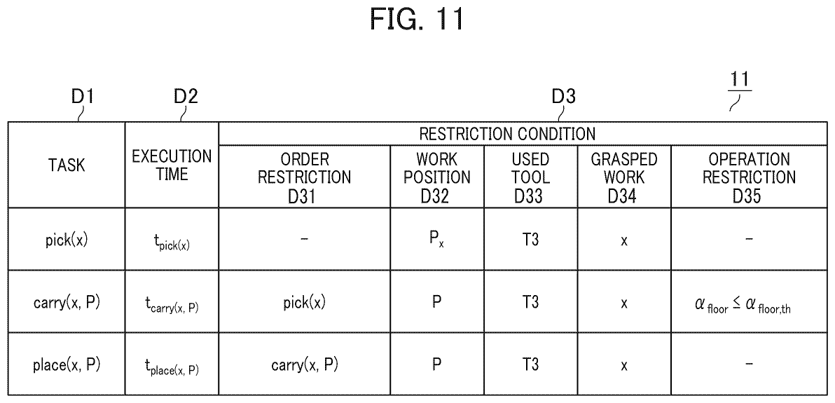

In the present embodiment, a description will be made about a case in which tasks shown in FIG. 11 are added as tasks to be executed by the robots R1 and R2.

In FIG. 11, the work is conducted in which a task pick (x) picks up an object x, a task carry (x, P) carries the object x picked up by the task pick (x) to a position P, and a task place (x, P) places the object x carried by the task carry (x, P) down to the position P.

Here, an operation restriction D35 is defined for the task carry (x, P). This means that when the vibration α_{floor} of the work floor 4 is larger than the threshold value α_{floor, th} upon transporting the object x using a hand T3, the object x will fall from the hand T3 due to the inertial force of the object x. Here, the object x is defined as a container storing liquid therein and may be replaced with a situation in which the contents spill due to the vibration α_{floor} of the vibration of the work floor 4>α_{floor, th}.

The difference between the first embodiment and the second embodiment resides in that the control parameters of the task module carry (x, P) itself can be changed. The task carry (x, P) can reduce the risk of a grasped object dropping by reducing the moving acceleration of the robot.

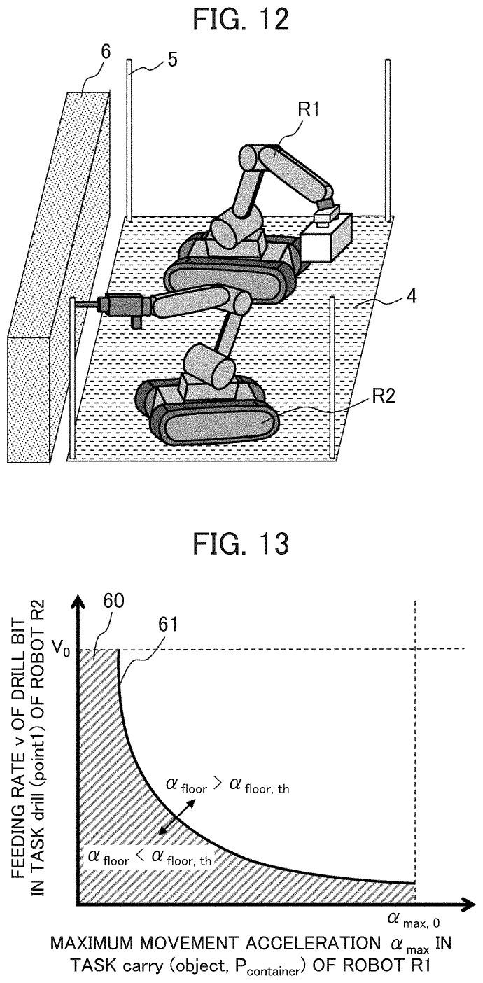

In the work environment shown in FIG. 12, the flow of processing will be described by taking as an example a situation in which the robot R1 executes a task carry (object, P_{container}), and the robot R2 executes a task drill (point1).

FIG. 13 shows α_{floor} when changing the maximum movement acceleration αₘₐₓ in the situation of FIG. 12 with the vertical axis representing the feeding rate v (control parameter) of a drill bit in the task drill (point1) of the robot R2 and the horizontal axis representing the maximum movement acceleration αₘₐₓ (control parameter) in the task carry (object, P_{container}) of the robot R1. The α_{floor} is determined by the combination (αₘₐₓ, V) of the control parameters of the robots R1 and R2, and the operation restrictions are satisfied in the case of the combination in a hatched portion 60 in FIG. 13. Therefore, it is optimal to use the combination in a curved portion 61.

In the plan generation section 12, when the execution time of each task at the time of overlapping the execution of the task drill (point1) of the robot R2 and the task carry (object, P_{container}) of the robot R1 is calculated by the execution time calculation unit 17, a huge amount of calculation time may be required when the control parameter calculation unit 16 evaluates all the optimal combinations of the control parameters obtained based on FIG. 13.

Therefore, for example, a method of evaluating a few of the optimal combinations, etc. are considered. At this time, for example, an analysis result by simulation can be used for the calculation of the execution time.

Further, when controlling the robots R1 and R2 based on the process planned by the plan generation section 12, the control parameters of both task modules are restricted in accordance with the processing steps S15 and S16 of FIG. 4 when the execution of the task module drill (point1) of the robot R2 and the execution of the task module carry (object, P_{container}) of the robot R1 overlap. At this time, the same combination as the control parameters determined in the process plan for the processing step S2 is required to be adopted for the control parameters.

### Third Embodiment

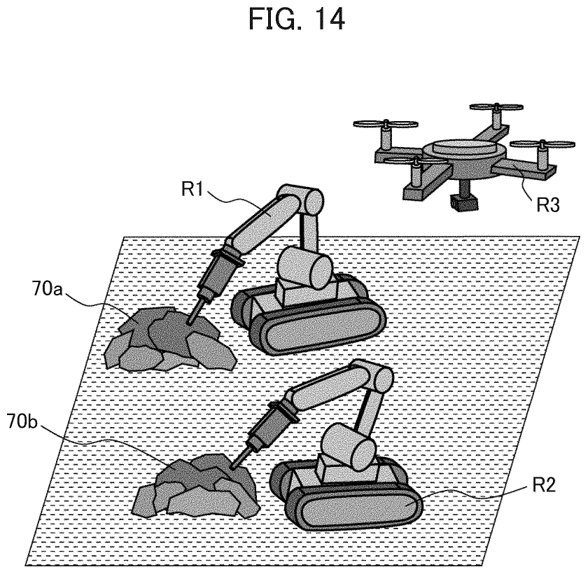

In the present embodiment, a process of working together robots R1 and R2 and an unmanned aircraft R3 (also a type of robot) simultaneously to execute the work of removing rubbles 70a and 70b in an unmaintained environment like a disaster site shown in FIG. 14 will be described as an example. The different between the first and second embodiments and the present embodiment resides in that there is a possibility that there are more than two robots to be controlled, and operation restrictions are required for two or more tasks with respect to a task requiring one operation restriction.

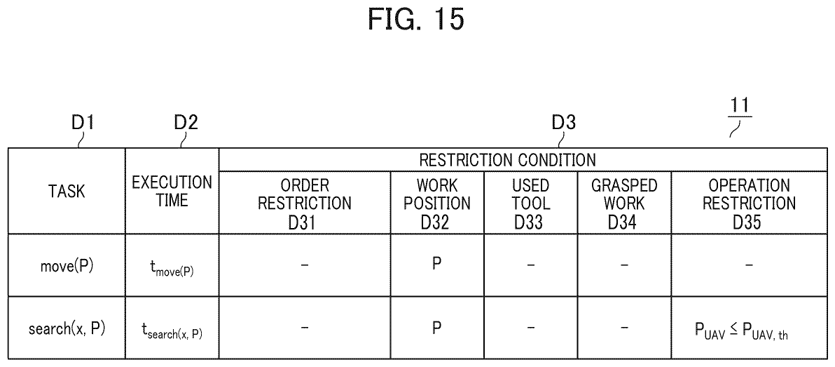

FIG. 15 is task information D3 executed by the unmanned aircraft R3. The robots R1 and R2 execute the tasks shown in FIG. 5. The unmanned aircraft R3 moves to a position P by a task move (P), and searches for the presence of a victim x at the position P by a task search (x, P).

At this time, the task search (x, P) is given an operation restriction P_{UAV}≤P_{UAV, th}. This means that an auditory sensor is used to investigate the presence of the victim x who is difficult to detect visually, but when the sound pressure P_{UAV} from the other task at the location of the unmanned aircraft R3 is greater than the threshold value P_{UAV, th}, a normal investigation cannot be performed. Here, instead of the sound pressure P_{UAV}, it is also conceivable to give an operation restriction to a noise frequency f_{UAV} like, for example, “f_{UAV}<f_{UAV, lower}, f_{UAV}>f_{UAV, upper}”.

The flow of processing will be described by taking as an example a situation shown in FIG. 14, in which the robots R1 and R2 execute a task drill (rubble) to break down rubble 70, and the unmanned aircraft R3 executes a task search (victims, P) to investigate victims.

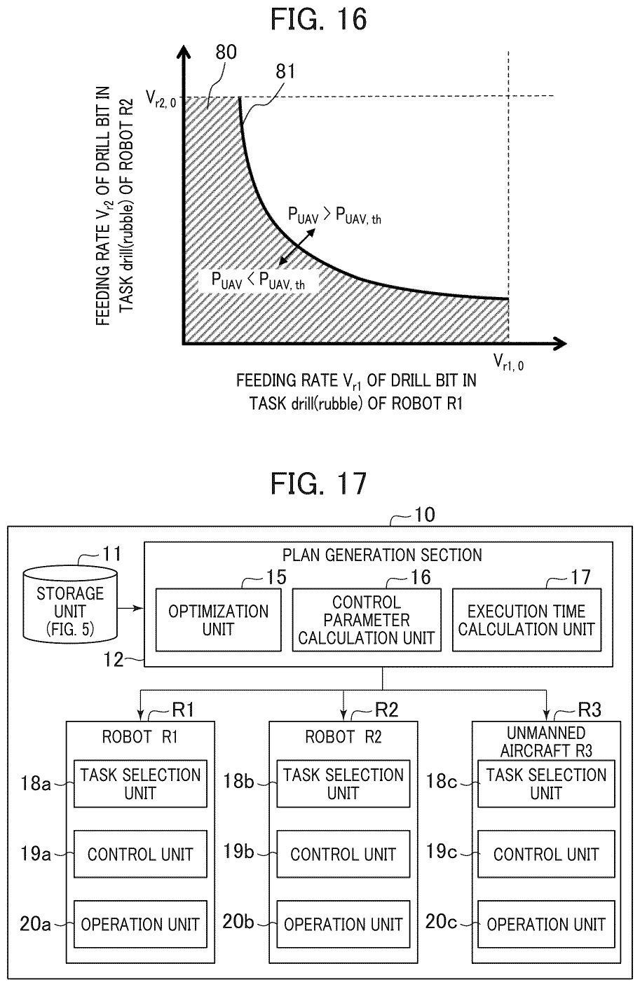

FIG. 16 shows P_{UAV} when changing a feeding rate Vᵣ₁ (control parameter) of a drill bit in the task drill (rubble) of the robot R1 and a feeding rate Vᵣ₂ (control parameter) of a drill bit in the task drill (rubble) of the robot R2 in the situation of FIG. 14. P_{UAV} is determined by the combination of the control parameters (Vᵣ₁, Vᵣ₂) of each of the robots R1 and R2, and the operation restrictions are satisfied in the case of a combination in a hatched portion 80 of FIG. 16. Therefore, it is optimal to use a combination in a curved portion 81.

In the case of the present embodiment, the plan generation section 12 plans processes for three robots of the robots R1 and R2 and the unmanned aircraft R3. The basic flow of processing is the same as in the first embodiment. However, when the execution time calculation unit 17 calculates the execution time of a task whose execution overlaps with a task which requires the operation restriction D35, it is necessary to use the optimal combination of control parameters obtained by the control parameter calculation unit 16 based on FIG. 16.

For example, when the execution times of the task search (victims, P) of the unmanned aircraft R3 and the task drill (rubble) of the robots R1 and R2 overlap, several points are selected from the combinations of control parameters (Vᵣ₁, Vᵣ₂) in the curved portion 81 in FIG. 16, the execution time for each combination is calculated, and multiple partial processes are created. At this time, for example, an analysis result by simulation can be used for the calculation of the execution time.

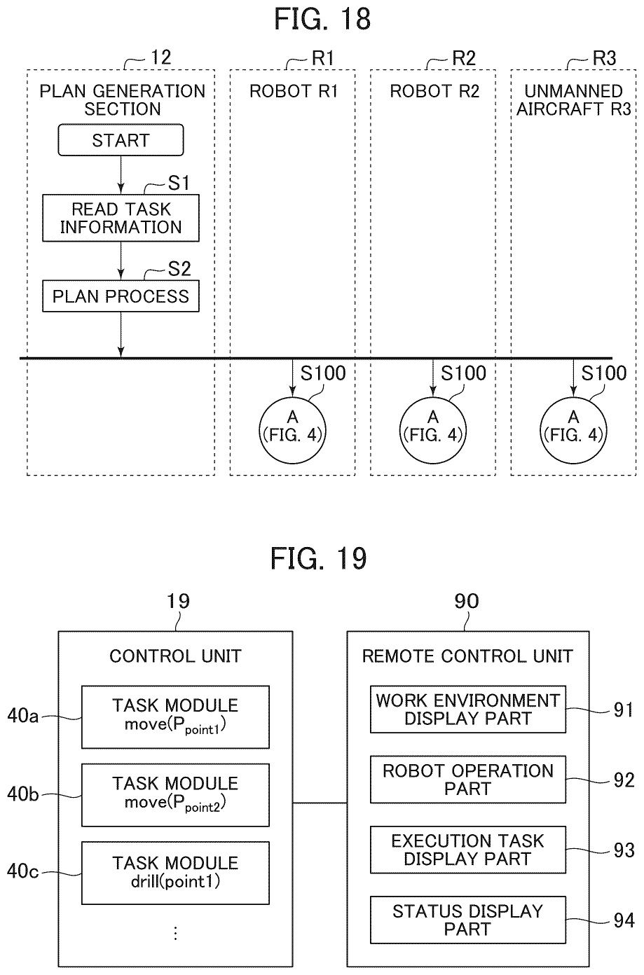

FIG. 17 is the configuration of the control system according to the present embodiment and is a configuration in which the unmanned aircraft R3 is added to the configuration of FIG. 2. Further, FIG. 18 is the flow of processing in the control system according to the present embodiment, in which a flow for controlling the unmanned aircraft R3 is added to the configuration of FIG. 3.

When controlling the robots R1 and R2 based on the process planned in the plan generation section 12, the control parameters of the task modules of both the robots R1 and R2 are restricted in accordance with the processing steps S15 and S16 of FIG. 4 in a case where the execution of the task module drill (rubble) of each of the robots R1 and R2 and the execution of the task module search (victims, P) of the unmanned aircraft R3 overlap. At this time, the same combination as the control parameters determined in the process plan for the processing step S2 is required to be adopted for the control parameters.

In the above description, the effect of noise from the task of dismantling rubble on the task of investigating victims was imposed as the operation restriction. On the other hand, similar processing can be performed even if the former is replaced with a task of detecting abnormal sounds from a machine and the latter is replaced with a task in which welding or driving sounds of the robot itself are problematic, or the like.

In the present embodiment, the change points when the number of control targets is increased from two to three have been described, but similar expansion can be conducted even when the number of control targets is increased to more than that.

### Fourth Embodiment

FIG. 19 is a configuration in which at least one of the task modules shown in FIG. 9 is replaced with remote control of the robot R1 or R2 by an operator. A remote control unit 90 is comprised of a work environment display part 91, a robot operation part 92, an execution task display part 93, and a status display part 94.

The work environment display part 91 displays an image of a work environment in real time and allows the operator to confirm the work environment and the status of the robot. The robot operation part 92 is a user interface for allowing the operator to control the robot. The operation of the robot is controlled based on information input to the interface by the operator.

The execution task display part 93 displays the contents of the task to be executed by the activated task module. For example, when a task module move (Pₚₒᵢₙₜ₁) is started, an instruction to move the controlled robot to a position Pₚₒᵢₙₜ₁ is displayed. At this time, it is also possible to achieve an improvement in operability and the like by displaying the position Pₚₒᵢₙₜ₁ on the work environment display part 91. The status display part 94 displays the execution status of the task, and allows the operator to confirm the completion determination of the task, the restriction conditions imposed on the task, and the like.

Here, in the processing step S16 of FIG. 4, when the control parameters of the remotely-operated task module are restricted based on the operation restrictions, the operation is restricted in the robot operation part 92 so that the control parameters do not exceed the threshold value set by the operation restrictions. For example, when a motion restriction Vₘₐₓ<V_{max, th} on the maximum speed Vₘₐₓ is imposed on the task module move (Pₚₒᵢₙₜ₁), it is conceivable for the robot operation part 92 to take a method of receiving only an input from the operator regarding the direction of travel and internally determine Vₘₐₓ, etc.

### Fifth Embodiment

In the first embodiment, the configuration of the control system shown in FIG. 2 includes a task selection unit 18 and a control unit 19 for each of the robots R1 and R2.

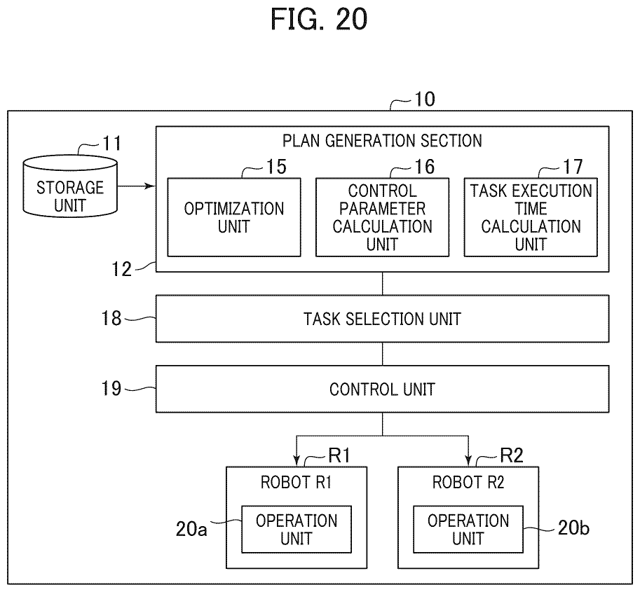

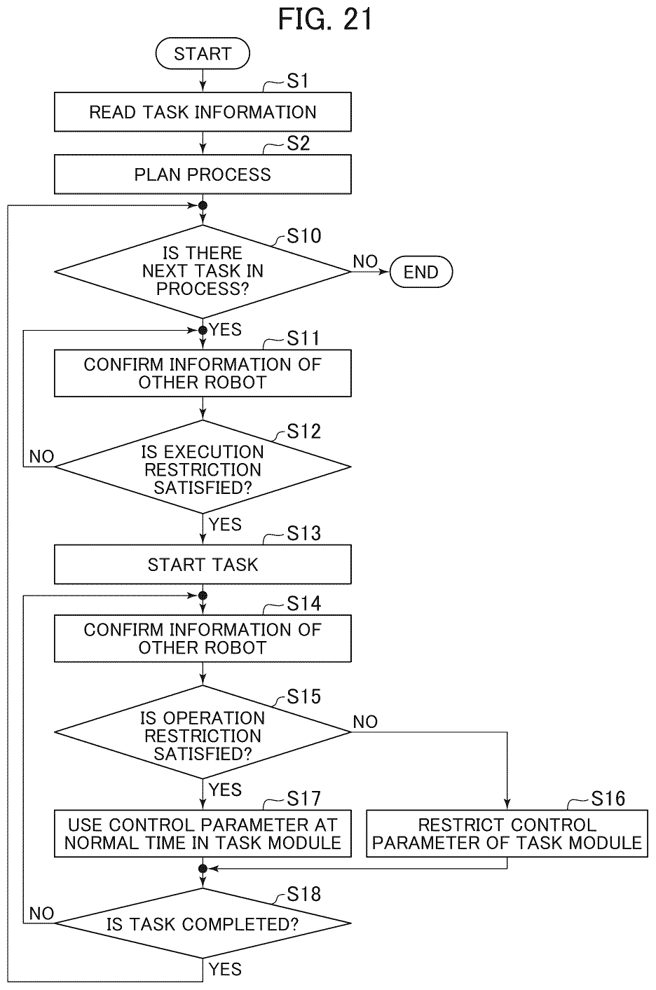

On the contrary, in the fifth embodiment, as in the configuration of a system in FIG. 20, the task selection unit 18 and the control unit 19 are integrated by the robots R1 and R2. In that case, the flow of processing in the control system is as shown in FIG. 21, and in each of the processing steps S10 to S18, the processing is performed to both robots R1 and R2. Alternatively, the series of processing in the processing steps S10 to S18 may be performed alternately to the robots R1 and R2.

### Sixth Embodiment

In the present embodiment, a description will be made about a case in which the operation restriction changes in the middle of the task.

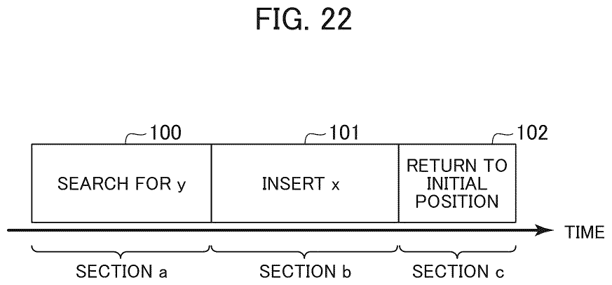

FIG. 22 is a configuration when the task insert (x, y) in FIG. 5 is divided into element operations. A task insert (x, y) to insert an object x into an object y can be divided into three operations of an operation 100 for searching for y, an operation 101 for inserting x, and an operation 103 for returning to the initial position after releasing x.

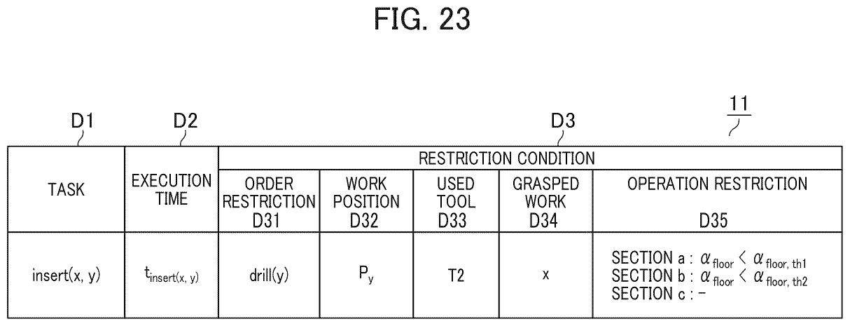

FIG. 23 is restriction conditions for the task insert (x, y) when the task can be divided into the element operations as shown in FIG. 22. Since the degree of the effect of vibration of the work floor 4 varies for each element operation, different operation restrictions are imposed on the execution of each operation. Since there is a possibility that the operations 100 and 101 may fail due to the vibration of the work floor 4, operation restrictions are given to sections a and b during which the operations are performed.

On the other hand, since the operation 102 is not affected by the vibration of the work floor 4, no operation restriction is imposed on a section c during which the operation 102 is executed. Further, since higher positioning accuracy is required for the operation 100 than for the operation 101, a threshold value α_{floor, th1} of the operation restriction for the section a is smaller than a threshold value α_{floor, th2} of the operation restriction for the section b.

In the processing step S14 of the flowchart in FIG. 4, when other robot is executing the task insert (x, y), the conditions for the operation restrictions are switched depending on which element operation of the task insert (x, y) is being executed. Thus, the determination result in processing step S15 and the value of the control parameter selected in the processing step S16 change.

Thus, it is possible to select more appropriate control parameters than when the conditions for the operation restrictions are constant within the task as shown in FIG. 5, and more efficient process control is realized.

### REFERENCE SIGN LIST

R1: robot
R2: robot
10: control system
11: storage unit
12: plan generation section
15: optimization unit
16: control parameter calculation unit
17: execution time calculation unit
18: task selection unit
19: control unit
20: operation unit
40: task module

1. A control system which controls each of a plurality of robots operated in the same work environment, the control system comprising:
a control parameter calculation unit which calculates control parameters for the plurality of robots;
an optimization unit which generates processes for the plurality of robots based on the control parameters;
a task module selection unit which selects a task module for each of the plurality of robots based on the processes; and
a control unit which controls the plurality of robots based on the task modules,
wherein the optimization unit restricts a task of the other robot when execution times of tasks affecting each other overlap.

2. The control system according to claim 1, wherein the restriction of the task of the other robot is delay processing of the time of task execution.

3. The control system according to claim 1, wherein the restriction of the task of the other robot is slowing down of the operation of the robot.

4. The control system according to claim 1, wherein the restriction of the task of the other robot is conducted by changing the control parameters.

5. A control system which controls each of a plurality of robots operated in the same work environment, the control system comprising:
a control parameter calculation unit which calculates control parameters for the plurality of robots;
an optimization unit which generates processes for the plurality of robots based on the control parameters;
a task module selection unit which selects a task module for each of the plurality of robots based on the processes; and
a control unit which controls the plurality of robots based on the task modules, wherein
when execution times of tasks affecting each other overlap, the control parameter calculation unit imposes an operation restriction on the operation of the other robot in order to reduce the effect on the task execution of one robot, to calculate the control parameters, and
when the execution times of the tasks affecting each other overlap, the optimization unit calculates the time required for the other robot to execute the task based on the control parameters for the other robot, and generates processes for the plurality of robots based on the calculation results.

6. The control system according to claim 5, wherein the control unit switches the control parameter for the other robot according to the status of execution of the task for the one robot.

7. The control system according to claim 5, wherein the control parameter includes either the speed, acceleration, angular speed, or angular acceleration related to the operation of the robot.

8. The control system according to claim 5, wherein the control parameter calculation unit gives a conditional formula for a physical quantity which makes an effect as to whether or not the task is executed, and calculates such a control parameter as to satisfy the conditional formula.

9. The control system according to claim 8, wherein the physical quantity is a physical quantity related to the vibration of an object in an environment in which the plurality of robots work, or a physical quantity related to noise at a certain location in a work environment.

10. The control system according to claim 5, wherein an execution time of the task executed by the other robot at a normal time, a time at which the execution of the task executed by the one robot and the execution of the task executed by the other robot overlap, a control parameter of the other robot at a normal time, and a control parameter which is calculated by the control parameter calculation unit and which is at a time when restricted by the operation restriction of the other robot, are used for calculation of the time required for the other robot to execute the task.

11. The control system according to claim 5, wherein the control parameter calculation unit calculates control parameters of the other robot and the one robot; when the task execution times of the plurality of robots overlap, the optimization unit calculates the time required for the other robot and the one robot to execute the task based on the control parameters for the other robot and the one robot; and the control unit switches the control parameters for the other robot and the one robot depending on a task execution status of the one robot.

12. The control system according to claim 5, wherein based on the task module, any of the plurality of robots is controlled by an operator through remote operation.

13. The control system according to claim 5, wherein the task module is comprised of two or more operations, and different operation restrictions are set for each operation.

14. A control method of controlling each of a plurality of robots operated in the same work environment, the control method comprising the steps of:
calculating control parameters for the plurality of robots; generating processes for the plurality of robots based on the control parameters; selecting a task module for each of the plurality of robots based on the processes; and controlling the plurality of robots based on the task modules; and
restricting a task of the other robot when execution times of tasks affecting each other overlap.
